(19) United States
(12) Patent Application Publication
(10) Pub. No.: US 2026/0200269 A1
(43) Pub. Date: Jul. 16, 2026

(54) BELTLESS TYRE FOR MOTOR VEHICLES

(71) Applicant: PIRELLI TYRE S.P.A., Milano (IT)

(72) Inventors: Piero LOSI, Milano (IT); Luca CAMOSI, Milano (IT); Davide MIAZZO, Milano (IT); Emanuele VANZETTI, Milano (IT)

(21) Appl. No.: 19/134,000

(22) PCT Filed: Dec. 6, 2023
(86) PCT No.: PCT/IB2023/062316

§ 371 Date: May 29, 2025

(30) Foreign Application Priority Data
Dec. 9, 2022 (IT) 102022000025269

(51) Int. Cl. B60C 9/06; B60C 9/00; B60C 9/04

(52) U.S. Cl. CPC B60C 9/06; B60C 9/005; B60C 9/0007; B60C 2009/0458

(57) ABSTRACT

A beltless tyre for motor vehicles has a carcass structure with two carcass plies, each with parallel cords crossed together. A reinforcing cord is wound in circumferential turns arranged in radially outer position with respect to the carcass structure. The reinforcing cord has a percentage elongation and is configured to exhibit a tensile load-elongation relationship according to a curve. The curve has a first region for elongation values less than the percentage elongation and a second region for elongation values greater than the percentage elongation. A ratio of the slope of the first region to the slope of the second region is greater than 1.

### TECHNICAL FIELD OF THE INVENTION

The present invention relates to a beltless tyre for motor vehicles. Preferably but not exclusively, the present invention relates to road tyres intended to equip hybrid or electric motor vehicles.

### Definitions

By “curvature ratio” in relation to a tyre it is meant the ratio between the distance of the radially outermost point of the tread band from the line passing through the laterally opposite ends of the tread itself, measured on a radial plane of the tyre and the distance measured along the tyre cord between said ends.

By “motor vehicle tyre” it is meant a tyre whose curvature ratio is indicatively less than 0.15, preferably between 0.03 and 0.1, more preferably close to 0.05. The terms “radial”, “axial” and “circumferential” refer to an axis of rotation of a tyre. By “radial plane” it is meant a plane in which the axis of rotation of the tyre lies.

By “beltless” tyre it is meant a tyre without a belt structure arranged between the carcass structure and the tread band and comprising layers provided with reinforcing cords crossed with each other.

The “tensile load-elongation” curve of a reinforcing cord means the curve drawn on a graph which has the elongation (for example the percentage elongation) of the reinforcing cord on the abscissa axis and the tensile force exerted on the reinforcing cord on the ordinate (for example expressed in N).

The “tensile load-elongation” curve for metallic cords is obtained according to the BISFA standard-Internationally agreed methods for testing steel tyre cords 1995, chapter E6.

The “tensile load-elongation” curve for textile cords is obtained according to the BISFA standard-Testing method for polyamide filament yarns 2004, chapter 7. By “density” it is meant the number of cords present per unit of width, for example 1 dm (EPDM).

By “textile cord” it is meant a cord made of a thread or several threads of the same textile material.

By “hybrid cord” it is meant a cord made of threads of at least two different textile materials.

By “metallic cord” it is meant a cord made of one or more metallic threads.

### Prior Art

A tyre for motor vehicles generally comprises a carcass structure associated with a belt structure.

The carcass structure comprises one or more carcass plies having respectively opposite terminal flaps engaged with respective annular anchoring structures, called bead cores, associated with a filling insert. The tyre area comprising the bead core and the filling insert forms a bead structure intended for anchoring tyre onto a corresponding mounting rim. The belt structure comprises several belt layers placed in radial overlap with respect to each other and with respect to the carcass structure, having metallic or textile or hybrid reinforcing cords with a crossed orientation with respect to a circumferential development direction of the tyre. A tread band is arranged in a radially outer position with respect to the belt structure.

Document US20190202241 illustrates a tyre with a belt structure comprising two or more layers. The layers are provided with steel or organic fibre cords inclined diagonally with respect to a circumferential direction of the tyre and forming an angle of no more than 10° with such direction.

Document DE 195 45 954 A1 illustrates a beltless tyre provided with a double cross-ply carcass. Each of the two plies includes polyamide reinforcing cords, parallel to each other and incorporated in an elastomeric layer. The cords of the two plies are crossed together and form an angle of between 20° and 40° with a circumferential direction of the tyre. In a radially outer position with respect to the carcass plies and under the tread, a band is arranged which extends circumferentially and is provided with parallel reinforcing elements oriented at an angle of approximately 0° with respect to the circumferential direction. The reinforcing elements of the band are polyamide monofilaments with a flattened, oval or elliptical section.

Document GB 769,325 illustrates a tyre comprising a carcass provided with thread-like reinforcing elements and a reinforcing ring consisting of rubberised metallic threads or textile cords. In one embodiment, the carcass comprises one or more carcass layers and such thread-like reinforcing elements form an angle of no more than 10° with respect to planes containing the rotation axis of the tyre. The reinforcing ring comprises one or more layers with the rubberised metallic threads or textile cords arranged at an angle of less than 20° with respect to a median circumferential plane. In another embodiment, the carcass comprises two or more carcass layers and such thread-like reinforcing elements form an angle with each other of no more than 20°. The reinforcing ring comprises a plurality of layers and the rubberised metallic threads or textile cords of one layer form an angle of no more than 40° with those of an adjacent layer.

Tyres with a radial carcass or with inclined cords are illustrated for example in documents US20130206309, U.S. Pat. Nos. 9,156,315, 4,967,817, 2,939,502A, and EP0093451A2. Reinforcing cords for tyres are illustrated for example in documents GB2034363A, EP1213159A2, EP0461646B1, EP0335588A2, US2004/0118499A1, WO2015/019214A1, WO2009/052844A1, WO2021/124133A1, WO2021/124138, WO2021/124154 and WO2022/064436.

### SUMMARY

The adoption of the layered belt structure provided with reinforcing cords crossed with respect to each other in the tyres was necessary to satisfy the request to adapt the tyres to the ever-increasing performance of motor vehicles and to improve the driving features in terms, for example, of stiffness, driving stability and driving readiness.

Tyres with a belt structure having belt layers having cross-oriented cords are in fact normally capable of providing a greater drift force, for the same drift angle, compared to beltless tyres. Tyres with such a belt structure are also normally capable of providing a greater self-aligning torque at low drift angles than beltless tyres.

For several years the Applicant has paid attention to the environmental impact exerted directly and indirectly by tyres during their use. In particular, in order to contain the consumption of motor vehicles which have an impact on energy consumption and also on the emission of carbon dioxide into the atmosphere, the Applicant produces tyres with low rolling resistance, i.e. tyres with a fuel efficiency class equal to “A” (according to the European Regulation EU 2020/740).

In this context, the Applicant has set itself the objective of further reducing the rolling resistance of tyres particularly but not exclusively intended to equip new hybrid and fully electric motor vehicles in order to reduce the environmental impact.

The Applicant has set itself the further objective of reducing consumption or increasing the autonomy of the vehicle.

The Applicant has set itself as a further objective that of reducing the heating of the tyres while driving.

In particular, the Applicant has set itself the aim of achieving the above objectives without compromising the performance and driving features of modern tyres, in particular tyres provided with a crossed belt structure.

However, the Applicant has unexpectedly found that the above objectives may be solved by adopting a particular beltless structure.

More precisely, the Applicant has found that the objectives indicated above may be achieved by means of a beltless tyre which combines a carcass structure with reinforcing cords crossed at appropriate pre-set angles together with a reinforcing structure (generally defined as a zero degree layer) comprising a reinforcing cord having a particular “tensile load-elongation” curve.

According to a first aspect thereof, the present invention relates to a beltless tyre for motor vehicles.

Preferably, said tyre comprises a carcass structure comprising two carcass plies, each of the two carcass plies comprising a plurality of parallel cords and having terminal flaps engaged with respective annular anchoring structures.

Preferably, the parallel cords of the two carcass plies are crossed with respect to each other and form an intersection angle with respect to each other of between 20° and 60°.

Preferably, the parallel cords of each of the two carcass plies delimit a respective angle of between 60° and 80° with a circumferential direction of the tyre.

Preferably, said tyre comprises at least one reinforcing cord wound in a plurality of circumferential turns arranged in radially outer position with respect to the carcass structure.

Preferably, said tyre comprises a tread band applied in a radially outer position with respect to the reinforcing cord.

Preferably, said at least one reinforcing cord has a predefined percentage elongation.

Preferably, said at least one reinforcing cord has a “tensile load-elongation” curve comprising a first section, placed upstream of the predefined percentage elongation, a second section, placed downstream of the predefined percentage elongation and a third connecting section placed between the first section and the second section.

Preferably, a second slope of the second section is greater than a first slope of the first section.

The Applicant has verified that the present invention allows the rolling resistance of tyres to be reduced to values lower than the rolling resistance of tyres provided with a belt structure.

The Applicant has also verified that the present invention allows performance and driving features suitable for the equipment of modern motor vehicles.

In particular, the Applicant has verified that the tyres made in accordance with the present invention are capable of providing a drift force comparable to the drift force provided by tyres provided with a belt structure.

The Applicant has also verified that the tyres made in accordance with the present invention provide a more progressive self-aligning torque curve compared to the curve provided by tyres provided with a belt structure and therefore a torque decay at the steering wheel that is more manageable by the driver.

The present invention, in at least one of the above aspects thereof, may exhibit one or more of the following preferred features.

Preferably, the first section is delimited between a zero percentage elongation and a first point of the “tensile load-elongation” curve, the second section develops downstream of a second point of the “tensile load-elongation” curve, the third connecting section is delimited between the first point and the second point.

Preferably, the first point corresponds to the first point of the “tensile load-elongation” curve, starting from said zero percentage elongation, in which the concavity of the “tensile load-elongation” curve is facing upwards.

Preferably, if downstream of the first point the concavity of the “tensile load-elongation” curve remains upwards until failure, the second point of the “tensile load-elongation” curve is the point with maximum concavity.

Alternatively, if downstream of the first point the concavity of the upward-facing “tensile load-elongation” curve becomes downward-facing at an inflection point, the second point of the “tensile load-elongation” curve is the inflection point.

Preferably, the predefined percentage elongation corresponds to the intersection between a first tangent to the “tensile load-elongation” curve in the first point and a second tangent to the “tensile load-elongation” curve in the second point. Preferably, the ratio of a second slope of the second section to a first slope of the first section is greater than 5.

Preferably, the circumferential turns of said at least one reinforcing cord are embedded in a layer of elastomeric material.

Preferably, the circumferential turns of said at least one reinforcing cord and the layer of elastomeric material define a reinforcing layer.

Preferably, the reinforcing structure is positioned directly against the carcass structure.

Preferably, the tread band is positioned directly against the reinforcing structure.

Preferably, the ratio of the second slope of the second section to the first slope of the first section is less than 50.

Preferably, the ratio of the second slope of the second section to the first slope of the first section is between 5 and 40, more preferably the ratio of the second slope of the second section to the first slope of the first section is between 10 and 35, for example equal to 27.

Preferably, the first slope of the first section is between 1 and 20 N/% elongation.

Preferably, the second slope of the second section is between 35 and 500 N/% elongation.

Preferably, the third connecting section forms a sort of elbow or knee with a concavity facing upwards.

Preferably, the first point coincides with the point of zero elongation, in which case the first section is reduced to the first point.

Preferably, the first section has a concavity facing downwards.

Preferably, the second section has a concavity facing upwards or a concavity facing downwards.

Preferably, a density of the circumferential turns of said reinforcing cord is between 40 turns/dm and 130 turns/dm, more preferably it is between 75 turns/dm and 115 turns/dm.

Preferably, the predefined percentage elongation is between 1% and 5%, more preferably, the predefined percentage elongation is between 1.5% and 4.5%, even more preferably, the predefined percentage elongation is 3%.

Preferably, in said “tensile load-elongation” curve a force corresponding to the predefined percentage elongation is between 5 N and 200 N, more preferably it is between 15 N and 90 N.

Preferably, said at least one reinforcing cord is metallic or hybrid.

Preferably, said at least one metallic reinforcing cord comprises a plurality of steel threads preferably of the same diameter, said threads being individually twisted and wound together in a manner such that in a plurality of transverse sections of said cord, each thread is not in contact with the immediately adjacent threads.

Preferably, said at least one metallic reinforcing cord comprises at least two strands, each comprising a respective plurality of steel threads, preferably of the same diameter, wound together in each strand according to a predetermined winding pitch, wherein said at least two strands are wound together in the same sense of said threads in said strands and with a winding pitch that is equal to or different from said predetermined winding pitch.

Preferably, said at least one metallic reinforcing cord comprises a single metallic thread or at least two metallic threads twisted together.

Preferably, said at least one metallic reinforcing cord comprises at least one helix-shaped metallic thread.

Preferably, said at least one hybrid reinforcing cord comprises one or more textile filaments with high elastic modulus twisted in one direction and one or more textile filaments with low elastic modulus twisted in the same direction, wherein the aforesaid textile filaments with high elastic modulus and the aforesaid textile filaments with low elastic modulus are twisted together.

Preferably, each yarn of the hybrid reinforcing cord has the filaments thereof twisted together according to a respective predetermined number of twists per unit of length of the yarn, and the different yarns are twisted together according to a predetermined number of twists per unit of length of the reinforcing cord.

Preferably, said at least one hybrid reinforcing cord comprises two aromatic polyamide fibre yarns and one polyamide aliphatic and/or polyester fibre yarn.

Preferably, said at least one hybrid reinforcing cord comprises at least one hybrid yarn, comprising a plurality of filaments obtained from a first yarn with many filaments having a first initial tangential module and at least one second yarn with many filaments having a second initial tangential module, said first initial tangential module and second initial tangential module being different from each other, wherein each of said first yarn and second yarn comprises a plurality of individual filaments, said individual filaments of each of said first yarn and second yarn being at least partially mixed together in said hybrid yarn.

Preferably, the circumferential turns of said reinforcing cord delimit, with the circumferential direction, an angle comprised between 0° and 5°

Preferably, said at least one reinforcing cord wound in a plurality of circumferential turns is embedded in a layer of elastomeric material.

Preferably said at least one reinforcing cord wound in a plurality of circumferential turns forms a reinforcing layer.

Preferably, said reinforcing layer is created by winding a continuous elongated element in turns placed close together, the continuous elongated element comprising said at least one reinforcing cord whereby said at least one reinforcing cord is wound in the plurality of circumferential turns.

Preferably, the continuous elongated element comprises elastomeric material and said at least one reinforcing cord is embedded into said elastomeric material.

Preferably, the continuous elongated element comprises a plurality of reinforcing cords.

Preferably, the continuous elongated element comprises a number of reinforcing cords between 1 and 500.

Preferably, the continuous elongated element has a flattened section.

Preferably, the reinforcing cords are arranged side by side in the continuous elongated element.

Preferably, a density of the reinforcing cords in the continuous elongated element is between 40 cords/dm and 130 cords/dm, more preferably between 75 cords/dm and 115 cords/dm.

Preferably, the carcass plies present in the carcass structure are two in number. Preferably, the parallel cords of each of the two carcass plies delimit an angle of between 65° and 75°, optionally equal to 70°, with the circumferential direction of the tyre.

Preferably, the parallel cords of the two carcass plies form equal and opposite angles with respect to the circumferential direction of the tyre. The parallel cords of the two carcass plies are therefore arranged symmetrically with respect to the circumferential direction of the tyre.

Alternatively, the parallel cords of the two carcass plies form different and opposite angles with respect to the circumferential direction of the tyre. The parallel cords of the two carcass plies are therefore arranged asymmetrically with respect to the circumferential direction of the tyre.

Preferably, the intersection angle is between 30° and 50°, optionally equal to 40°.

Preferably, the two carcass plies comprise a first carcass ply, preferably radially inner, and a second carcass ply, preferably radially outer.

Preferably, the cords of the first carcass ply are inclined, with respect to the circumferential direction of the tyre, by a first angle α measured in an anti-clockwise direction.

Preferably, the cords of the second carcass ply are inclined, with respect to the aforementioned circumferential direction, by a second angle β measured clockwise.

Preferably, the cords of the first carcass ply delimit an intersection angle Δ=180° −β-α with the cords of the second carcass ply.

Preferably, at least one auxiliary element is positioned at each of two opposite axial ends of the plurality of circumferential turns.

Preferably, the auxiliary element is placed between the plurality of circumferential turns and the tread band and/or between the plurality of circumferential turns and the carcass structure.

Preferably, it is provided to deposit at least one auxiliary element at each of two opposite axial ends of the circumferential turns.

Preferably, said at least one auxiliary element is positioned astride the respective axial end.

Preferably, it is provided to deposit the auxiliary element before winding the continuous elongated element in turns placed side by side, so that said at least one auxiliary element lies between the circumferential turns and the carcass structure and/or it is provided to deposit the auxiliary element after having wound the continuous elongated element in turns placed close together, so that said at least one auxiliary element lies between the circumferential turns and the tread band.

Preferably, the auxiliary element comprises elastomeric and/or aramid and/or metallic material.

Preferably, the auxiliary element has an axial extension between 15% and 25% of an axial width of the plurality of circumferential turns.

Preferably, it is provided to deposit the auxiliary element before winding the continuous elongated element in turns placed close together; winding the continuous elongated element in turns placed close to each other, leaving an axially outer portion of the auxiliary element free; folding the axially outer axial portion onto the respective axial end of the turns placed next to each other, so that the auxiliary element is positioned astride the respective axial end.

Further features and advantages will appear more clearly from the detailed description of preferred but non-exclusive embodiments of a beltless tyre for motor vehicles.

### DESCRIPTION OF THE DRAWINGS

Such description is given hereinafter with reference to the accompanying drawings, provided only for illustrative and, therefore, non-limiting purposes, in which:

FIG. 1 illustrates a section along a radial plane of a beltless tyre for motor vehicles according to the present invention;

FIG. 2 is an enlarged portion of FIG. 1;

FIGS. 3A and 3B are schematic views from above of elements of the tyre referred to in the preceding figures;

FIG. 4 illustrates a continuous elongated element used to make the tyre referred to in the preceding figures;

FIG. 5A illustrates a “tensile load-elongation” curve of a reinforcing cord of a tyre referred to in the preceding figures;

FIG. 5B illustrates a “tensile load-elongation” curve of a different reinforcing cord;

FIG. 5C illustrates a detail of the “tensile load-elongation” curves of FIGS. 5A and 5B;

FIG. 6 illustrates the rolling resistance of tyres compared to a reference tyre;

FIGS. 7A-7D, 8A-8D and 9A-9D illustrate the drift forces of the tyres according to the invention and of the reference tyre;

FIG. 10 illustrates the self-aligning torques of a pair of tyres according to the invention and of the reference tyre;

FIGS. 11, 12 and 13 are enlarged portions of variants of the tyre according to the present invention.

### DETAILED DESCRIPTION

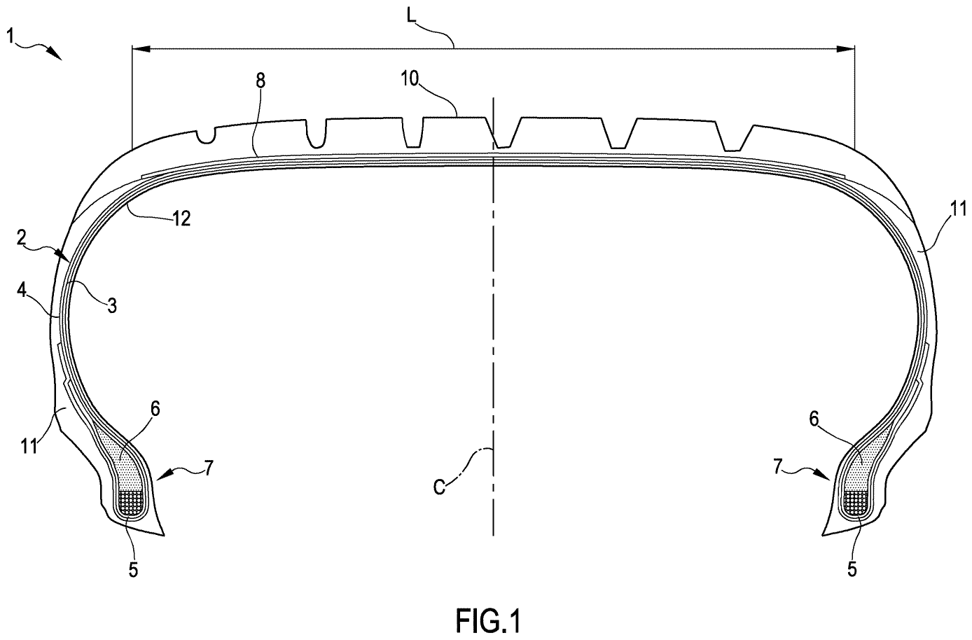

FIG. 1 illustrates a section along a radial plane of a beltless tyre 1 for motor vehicles according to the present invention.

The tyre 1 comprises a carcass structure 2, comprising a first radially inner carcass ply 3 and a second radially outer carcass ply 4. Each of the first carcass ply 3 and second carcass ply 4 has opposite terminal flaps engaged with respective annular anchoring structures 5, called bead cores, associated with a filling insert 6.

The tyre area 1 comprising the bead core 5 and the filling insert 6 forms a bead structure 7 intended for anchoring tyre 1 onto a corresponding mounting rim, not shown.

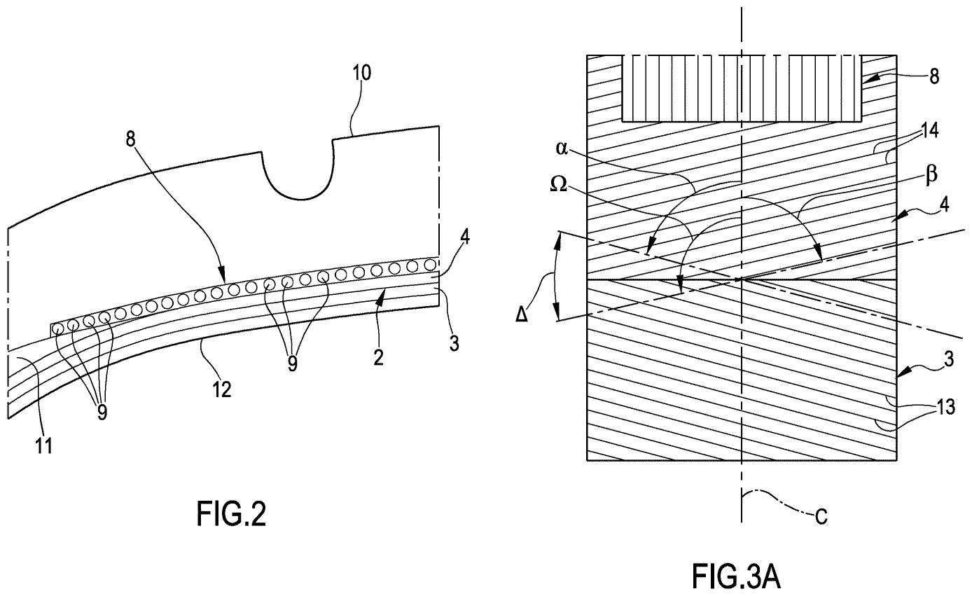

The carcass structure 2 is associated with a reinforcing structure 8 (zero degree layer) comprising at least one reinforcing cord 9 wound in a plurality of circumferential turns arranged in a radially outer position with respect to the carcass structure 2 (FIG. 2). The circumferential turns are arranged so as to form an angle preferably of between 0° and 5° with a circumferential direction C of the tyre 1.

The reinforcing structure 8 illustrated in FIGS. 1 and 2 comprises a layer of elastomeric material in which the circumferential turns of the reinforcing cord 9 are embedded. The reinforcing structure 8 is preferably positioned directly against the carcass structure 2, in particular against the second carcass ply 4.

The tyre 1 according to the invention is beltless and in a position radially outer to the reinforcing structure 8, a tread band 10 is applied, made of an elastomeric compound like other semi-finished products making up the tyre 1. The tread band 10 is positioned directly against the reinforcing structure 8.

Moreover, respective sidewalls 11 of elastomeric compound are applied in an axially external position on the lateral surfaces of the carcass structure 2, each extending from one of the lateral edges of the tread band 10 at the respective bead structure 7.

A layer of waterproof rubber 12, generally known as a “liner”, which provides the necessary impermeability to the inflation air of the tyre 1, is arranged in a radially inner position with respect to the first carcass ply 3. The waterproof rubber layer 12 is preferably applied directly against the first carcass ply 3.

Each of the two carcass plies 3, 4 comprises a plurality of cords 13, 14 parallel to each other and covered by or embedded in elastomeric material. Such parallel cords 13, 14 of the two carcass plies 3, 4 may be textile and/or hybrid.

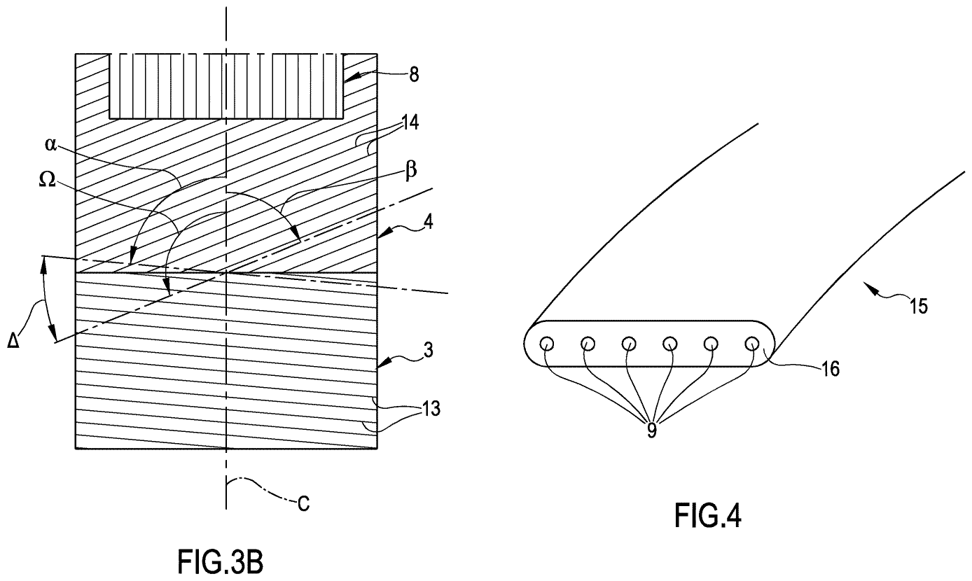

As illustrated in FIGS. 3A and 3B, the cords 13 of the first carcass ply 3 are inclined, with respect to the circumferential direction C of the tyre 1, by a first angle α measured in an anti-clockwise direction and the cords 14 of the second carcass ply 4 are inclined, with respect to the aforementioned circumferential direction C, of a second angle β measured in a clockwise direction. From a different point of view, the cords 14 of the second carcass ply 4 are inclined, with respect to the aforementioned circumferential direction C, by a third angle Ω measured in an anti-clockwise direction, where Ω=180°−β.

Therefore, the cords 13 of the first carcass ply 3 are crossed with respect to the cords 14 of the second carcass ply 4. The cords 13 of the first carcass ply 3 delimit an intersection angle Δ=180°−β−α=Ω−α with the cords 14 of the second carcass ply 4.

Examples of such angles are shown in Table 1 below. In cases B, C, D, the two carcass plies 3, 4 are inclined at equal and opposite angles with respect to the circumferential direction C of the tyre 1, as illustrated in the example of FIG. 3A (the parallel cords 13, 14 of the two carcass plies 3, 4 are arranged symmetrically with respect to the circumferential direction C of the tyre 1). In cases F and G, the two carcass plies 3, 4 are inclined at different and opposite angles with respect to the circumferential direction C of the tyre 1, as illustrated in the example of FIG. 3B (the parallel cords 13, 14 of the two carcass plies 3, 4 are arranged asymmetrically with respect to the circumferential direction C of the tyre 1).

TABLE 1

| | α | β | Ω | Δ |
|---|---|---|---|---|
| B | 60° | 60° | 120° | 60° |
| C | 70° | 70° | 110° | 40° |
| D | 80° | 80° | 100° | 20° |
| F | 75° | 65° | 115° | 40° |
| G | 80° | 60° | 120° | 40° |

The reinforcing cord 9 wound in circumferential turns and part of the reinforcing structure 8 has a predefined percentage elongation Sp between 1% and 5%, preferably between 1.5% and 4.5%, for example equal to 3%.

Such reinforcing cord 9 also has a “tensile load-elongation” curve comprising a first section T1, located upstream of the predefined percentage elongation Sp and provided with a first slope measured in a first point P1, and a second section T2, placed downstream of the predefined percentage elongation Sp and provided with a second slope measured at a second point P2, where the second slope is greater than the first slope. In other words, the reinforcing cord 9 increases its stiffness when it is stretched beyond the predefined percentage elongation Sp. Given that in the finished tyre 1 the reinforcing cord 9 has such predefined percentage elongation Sp, then this means that when, during the rolling of the tyre 1 on the road, said tyre 1 deforms so as to put the reinforcing cord 9 under traction or portions thereof, then the reinforcing cord 9 behaves as if it had a high stiffness corresponding to the slopes of the second section T2.

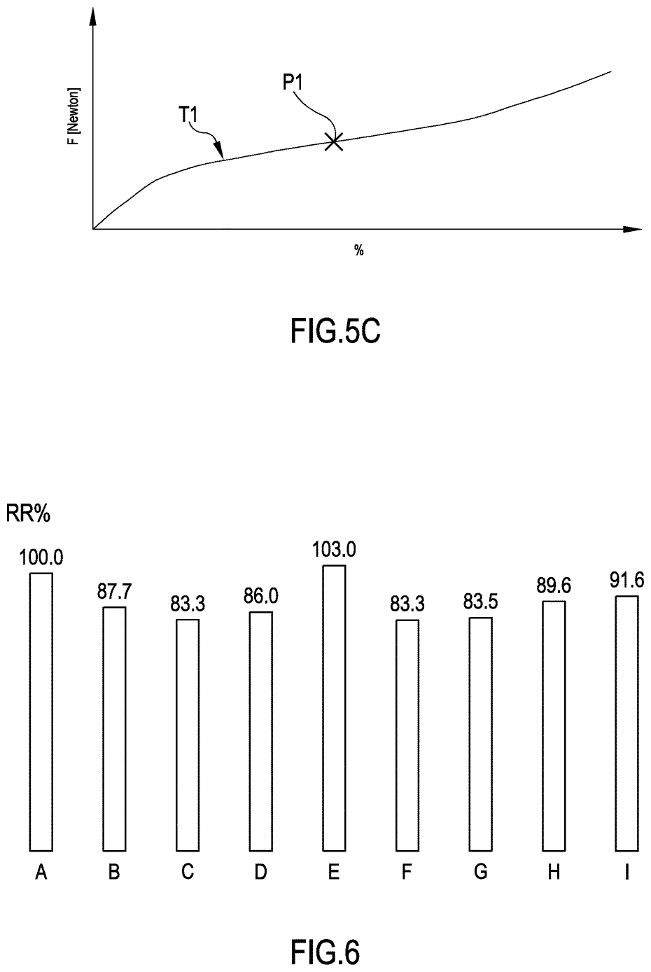

Examples of such “tensile load-elongation” curve are illustrated in the graphs of FIGS. 5A and 5B which show the percentage elongation (%) of some possible reinforcing cords 9 according to the invention on the abscissae and the tensile force (expressed in Newton) on the ordinates.

The first section T1 is delimited between the zero elongation and the first point P1 of the “tensile load-elongation” curve, the second section T2 develops downstream of the second point P2 of the “tensile load-elongation” curve, a third connecting section K is delimited between the first point P1 and the second point P2. The first section T1 and the second section T2 of the “tensile load-elongation” curve are connected by the third connecting section K with an increasing slope. The third connecting section K forms a sort of elbow or knee with a concavity facing upwards.

The “tensile load-elongation” curve in FIG. 5A refers to a 3×4×0.20 HEHT steel metal cord.

As may be seen, the “tensile load-elongation” curve in FIG. 5A has the first section T1 with the concavity facing downwards (visible in the enlargement of FIG. 5C), followed by the third connecting section K with the concavity facing upwards and then by the second section T2 with the concavity facing first upwards and then downwards.

The curve in FIG. 5A therefore has an inflection point between the first section T1 and the third connecting section K and an inflection point at the beginning of the second section T2. The first point P1 corresponds to the first point of the “tensile load-elongation” curve encountered, starting from zero elongation, in which the concavity of the “tensile load-elongation” curve is facing upwards. In the graph of FIG. 5A, the first point P1 is placed just after the inflection point of the first section T1. The second point P2 is the inflection point at the beginning of the second section T2.

The “tensile load-elongation” curve in FIG. 5B refers to a hybrid cord of the ARx2/NY 1670/940 (20/20×20) type.

As may be seen, the “tensile load-elongation” curve in FIG. 5B has the first section T1 with the concavity facing downwards (as shown in FIG. 5C), followed by the third connecting section K with the concavity facing upwards and then by the second section T2, which unlike the curve in FIG. 5A, has a concavity always facing upwards (up to the breaking load).

As for FIG. 5A, the first point P1 corresponds to the first point of the “tensile load —elongation” curve encountered, starting from zero elongation, in which the concavity of the “tensile load-elongation” curve is facing upwards. Unlike FIG. 5A, the second point P2 of the “tensile load-elongation” curve in FIG. 5B is the point with maximum concavity.

In both FIGS. 5A, 5B, the predefined percentage elongation Sp corresponds to the elongation placed at the intersection between a first tangent to the “tensile load —elongation” curve in the first point P1 and a second tangent to the “tensile load-elongation” curve in the second point P2.

In the graph of FIG. 5A, the predefined percentage elongation Sp is equal to approximately 1.7% and a force F corresponding to such predefined percentage elongation Sp is equal to approximately 60 N. In the graph of FIG. 5B, the predefined percentage elongation Sp is equal to approximately 3.4% and a force F corresponding to such predefined percentage elongation Sp is equal to approximately 85 N.

The reinforcing cord 9 according to the invention has a force corresponding to the predefined percentage elongation Sp preferably between 5 N and 200 N, more preferably between 15 N and 90 N.

A ratio between the second slope and the first slope of the “tensile load-elongation” curve of the reinforcing cord 9 according to the invention is preferably greater than 5, more preferably between 5 and 40, even more preferably it is between 10 and 35, for example such ratio is equal to 27. For example, the first slope of the first section T1 is preferably comprised between 1 and 20 N/elongation % and the second slope of the second section T2 is preferably comprised between 35 and 500 N/elongation %. In the example of the graph of FIG. 5A, the first slope of the first section T1 is approximately 20 N/% elongation and the second slope of the second section T2 is approximately 470 N/% elongation, so the aforementioned ratio is approximately 24. In the example of the graph in FIG. 5B, the first slope of the first section T1 is approximately 12 N/% elongation and the second slope of the second section T2 is approximately 120 N/% elongation, so the aforementioned ratio is approximately 10.

To obtain this double slope behaviour, the reinforcing cord 9, also called “high elongation” for this behaviour, comprises, for example, two or more metallic threads twisted together or at least one helix-shaped metallic thread, as illustrated in the documents WO 2021/124133, WO 2021/124138, WO2021/124154A1, and WO 2022/064436A1, in the name of the same Applicant.

In a different example, the reinforcing cord 9 comprises a single strand of a number n of steel threads of a given diameter, said threads being individually twisted and helically wound together but not so tightly that each thread is in mutual contact with the immediately adjacent threads, for example as described in document GB 2034363A in the name of the same Applicant. As a particular example, the reinforcing cord 9 may be of the 1×5×0.25 or 5×0.25 type. These types of cords are described in the art as “open” precisely due to the fact that each component thread is not in contact with the immediately adjacent threads in a plurality of cross sections of the cord. This space is particularly useful as it allows the elastomeric material to flow during vulcanisation, filling every space and homogeneously rubberising the resulting cord: during use, infiltrations of humidity which are harmful to the cord itself are therefore avoided.

Another example of open-type reinforcing cord 9 provides 2 to 7 single-twist threads with penetration portions for the elastomeric material between reciprocal threads for the entire length of the cord, for example as illustrated in document EP1213159A2.

In a further example, the reinforcing cord 9 comprises a given number of strands, for example 2 to 5, each strand being made up of a certain number of metallic threads, for example 2 to 10 preferably having a diameter of between 0.12 mm and 0.25 mm. The threads in the strands and the strands in the cord are helically wound together in the same direction with equal or different winding pitches for the threads and strands. As a particular example, a cord of the 3×7×0.12 HE type may be used as reinforcing cord 9, for example as described in document EP0461646B1 in the name of the same Applicant, or a cord of the 3×4×0.20 HEHT type as described above.

The reinforcing cord 9 may also be of the hybrid type, for example formed by twisting one or more filaments with a high elastic modulus (for example of aromatic polyamide fibre) in one direction and one or more filaments with a low elastic modulus (for example of aliphatic polyamide fibre) in the same direction and finally twisting the aforementioned high elastic modulus and low elastic modulus filaments together, preferably in the opposite direction, for example as described in document EP0335588A2.

In another example, each yarn of the reinforcing cord 9 may have its filaments twisted together a given number of times per unit length of the yarn, more preferably several yarns are twisted together a given number of times per unit length of the cord, for example as illustrated in document US2004/0118499A1.

Furthermore, the twisting directions of the cord or yarn are different compared to the direction of the cord or yarn itself held vertically. The filaments are of high elastic modulus (for example aromatic polyamide) and low elastic modulus (for example aliphatic polyamide).

The reinforcing cord 9 may also be consist of two aromatic polyamide fibre yarns and one aliphatic polyamide and/or polyester fibre yarn assembled by means of a twisting process in which the aromatic polyamide fibre yarn has suitable linear density and initial elastic modulus features, for example as illustrated in document WO2015/019214A1 in the name of the same Applicant.

A further example of reinforcing cord 9 comprises at least one hybrid yarn, preferably twisted, comprising a plurality of filaments obtained from a first yarn with many filaments having a first initial tangential module and at least one second yarn with many filaments having a second initial tangential module, said first and second initial tangential module being different from each other, wherein each of said first yarn and second yarn with many filaments comprises a plurality of individual filaments, said individual filaments of each of said first yarn and second yarn being at least partially mixed together, for example as illustrated in document WO2009/052844A1 in the name of the same Applicant.

Since the reinforcing structure 8 comprises the plurality of circumferential turns formed by the reinforcing cord 9, the reinforcing structure 8 also has a respective stiffness which depends on the density of the circumferential turns and on the features of the reinforcing cord 9. For example, a density of the circumferential turns is preferably between 40 turns/dm and 130 turns/dm, more preferably it is between 75 turns/dm and 115 turns/dm.

The tyre 1 described above may be made through the following steps.

For example, it is provided to make the carcass structure 2 as described above by depositing the various structural components on a building drum. The built carcass structure 2 preferably comprises the waterproof rubber layer (or liner) 12, the first carcass ply 3, the second carcass ply 4, the bead structures 7 and the sidewalls 11.

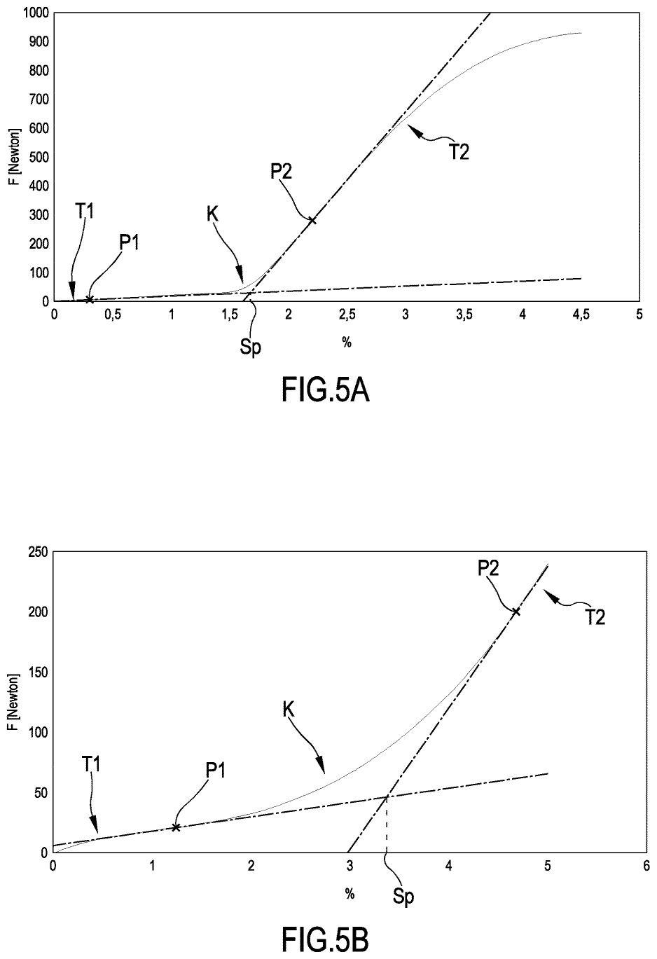

A continuous elongated element 15 (partially illustrated in FIG. 4) which comprises one or more reinforcing cords 9 embedded in or covered by elastomeric material 16 is then wound around the carcass structure 2, in turns placed close to each other or partially overlapping. The continuous elongated element 15 preferably comprises a number of reinforcing cords 9 between 1 and 500. In the exemplary embodiment of FIG. 4, the continuous elongated element 15 has a flattened section and comprises reinforcing cords 9 arranged side by side. A density of the reinforcing cords 9 in the continuous elongated element 15 is preferably between 40 cords/dm and 130 cords/dm, for example equal to 75 cords/dm. The winding of the continuous elongated element 15 also arranges the reinforcing cords 9 according to the aforementioned plurality of circumferential turns.

During deposition, the continuous elongated element 15 is placed under tension so as to give said continuous elongated element 15 and the respective reinforcing cords 9 a first percentage elongation, which is substantially maintained once the continuous elongated element 15 is wound and applied around the carcass structure 2.

The deposition of the continuous elongated element 15 forms the reinforcing structure 8 which extends axially until it overlaps at the axial ends opposite the terminal flaps of the sidewalls 11, as illustrated in FIG. 1.

Finally, the tread band 10 is placed around the reinforcing structure 8. The tread band 10 is applied against the reinforcing structure 8 and against end portions of each of the two sidewalls 11 (FIGS. 1 and 2).

The green tyre 1 thus built is inserted into a vulcanisation mould where a moulding and vulcanisation treatment is carried out aimed at determining the structural stabilisation of the tyre 1 through cross-linking of the elastomeric material, as well as imparting a desired tread pattern on the tread band 10 and any distinctive graphic signs at the sidewalls 11.

During moulding and vulcanisation, the green tyre 1, in addition to being heated, is made to expand radially by introducing a pressurised gas inside it or into a membrane lying inside it, to radially press a radially outer surface against the mould.

During moulding and vulcanisation, the reinforcing cords 9 of the reinforcing structure 8 are subjected to a second percentage elongation by virtue of the action of the pressurised gas.

All the circumferential turns, after vulcanisation and moulding, exhibit an elongation which, depending on the deposition process (on a cylindrical or toroidal surface), may vary based on the axial positioning and corresponds with a certain approximation to the predefined percentage elongation Sp illustrated above.

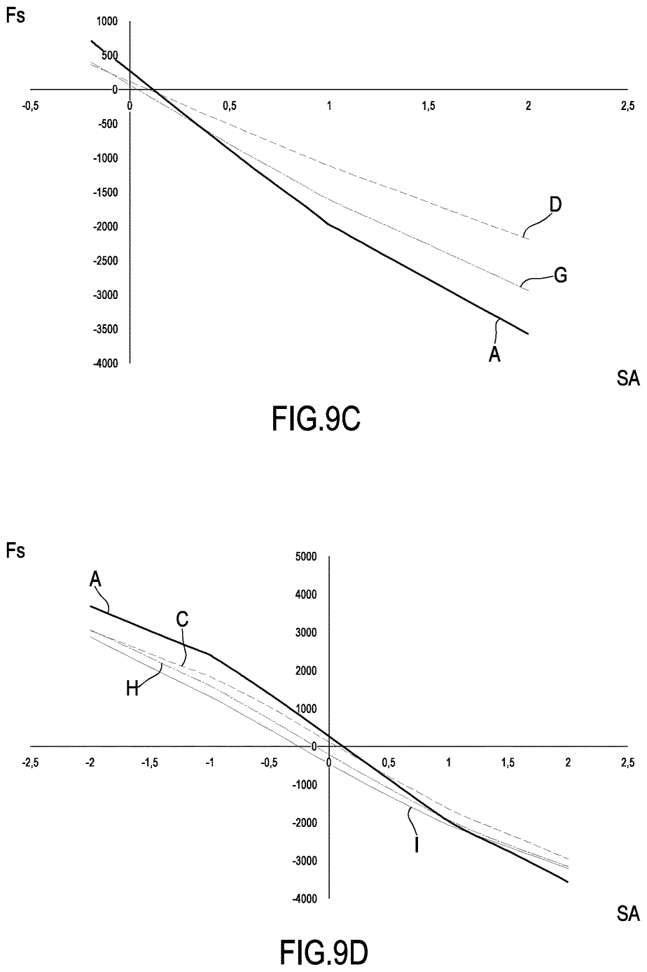

FIGS. 11, 12 and 13 illustrate respective variants of the tyre 1 according to the invention. These variants also include at least one auxiliary element 17, 17A, 17B positioned at each of two opposite axial ends of the plurality of circumferential turns or of the reinforcing structure 8. This auxiliary element 17, 17A, 17B is, for example, a tape comprising elastomeric and/or aramid and/or metallic material which is wound at each of the aforementioned two opposite axial ends of the reinforcing structure 8.

For the variant of FIG. 11, the auxiliary element 17 is placed before placing the reinforcing structure 8. Then the continuous elongated element 15 is wound, leaving an axially outer portion of the auxiliary element 17 free. Said axially outer portion of the auxiliary element 17 is then turned over on the reinforcing structure 8, so that the auxiliary element 17 is positioned astride an edge of the respective axial end of the reinforcing structure 8. Finally, the tread band 10 is applied.

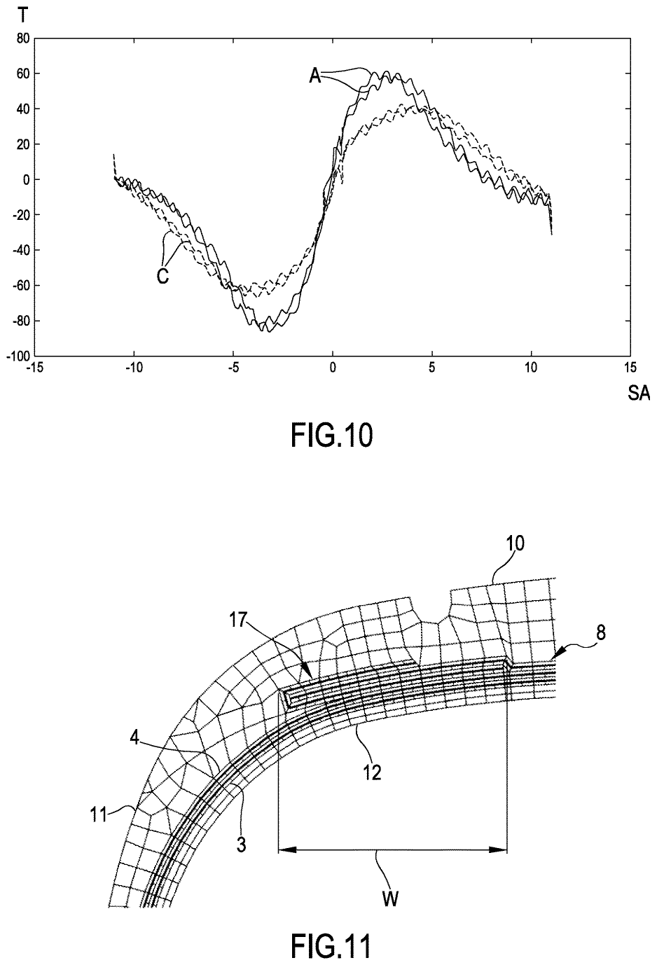

The variant of FIG. 12 comprises a first auxiliary element 17A placed above the reinforcing structure 8, i.e. in a radially outer position with respect to the reinforcing structure 8, and a second auxiliary element 17B placed under the reinforcing structure 8, i.e. in a radially inner position with respect to the reinforcing structure 8. In this variant, each of the two opposite axial ends of the reinforcing structure 8 is associated with two distinct auxiliary elements.

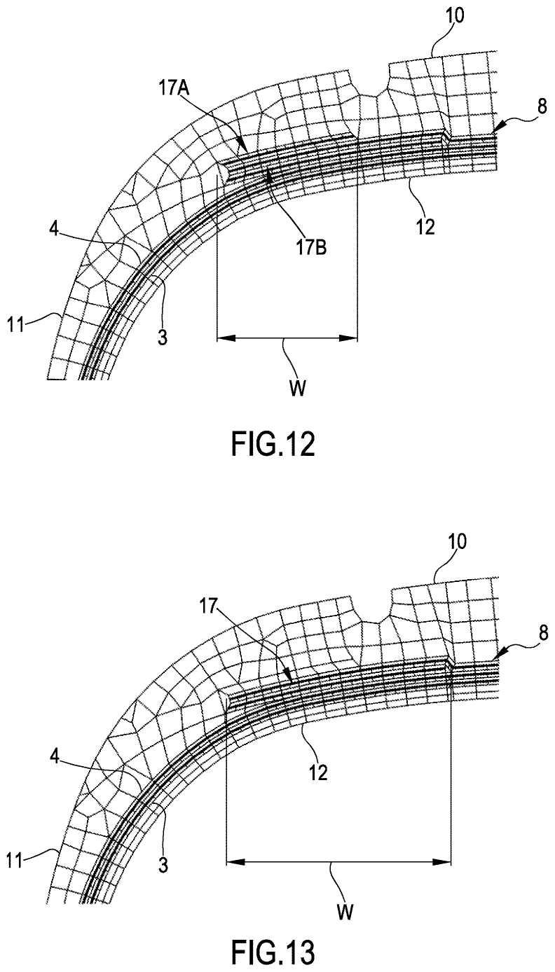

The variant of FIG. 13 comprises a single auxiliary element 17 for each of the two opposite axial ends of the reinforcing structure 8. Such auxiliary element 17 lies under the reinforcing structure 8, i.e. in a radially inner position with respect to the reinforcing structure 8.

In all three illustrated variants, the auxiliary elements 17, 17A, 17B lie in a radially outer position with respect to the terminal flap of the respective side 11. Furthermore, the single auxiliary element 17 or the first and second auxiliary elements 17A, 17B exhibits an axial extension “W” (indicated in FIGS. 11, 12 and 13) between 15% and 25% of an axial width “L” of the plurality of circumferential turns (indicated in FIG. 1), i.e. of the reinforcing structure 8.

### Tests

Eight tyres B, C, D, E, F, G, H, I were compared via a finite element simulation (FEA) with a reference tyre A. All tyres represent a P7 Cinturato model in size 245/45 R18 100Y. Reference tyre A includes a radial mono-ply carcass structure, a two-ply belt structure with crossed cords and a hybrid zero-degree ply, i.e. made up of hybrid cords. The eight tyres B, C, D, E, F, G, H, I comprise a carcass structure with two cross-plies and a metallic zero-degree layer (i.e. formed by metallic cords) with a double slope as illustrated above. The eight tyres B, C, D, E,

F, G, H, I are without belt structure, i.e. they do not comprise belt layers with crossed cords. The eight tyres B, C, D, E, F, G, H, I differ from each other in the angles α, β, Ω and Δ of the cords 13, 14 of the carcass plies 3, 4, as per the following Tables 2A and 2B. Tyres B, C, D, F, G are the same as in Table 1.

### Materials Used for the Simulation:

carcass ply cords: RY 1840/2 (48×48) EPDM 120;
zero degree metallic (steel): 2×0.15 HE EPDM 79;
zero degree hybrid: AR/NY 1100/1400 (28/7×28) EPDM 79.

TABLE 2A

| | A reference | B | C | D |
|---|---|---|---|---|
| Carcass | radial | two | two | two |
| structure | mono-ply | crossed | crossed | crossed |
| | | plies | plies | plies |
| | | α = 60° | α = 70° | α = 80° |
| | | β = 60° | β = 70° | β = 80° |
| | | Ω = 120° | Ω = 110° | Ω = 100° |
| | | Δ = 60° | Δ = 40° | Δ = 20° |
| Belt | two layers | — | — | — |
| structure | with | | | |
| | crossed | | | |
| | cords | | | |
| Reinforcing | zero degree | zero | zero | zero |
| layer | hybrid | degree | degree | degree |
| | | metallic | metallic | metallic |
| | | with | with | with |
| | | double | double | double |
| | | slope | slope | slope |
| Weight | 100 | 92.6 | 92.6 | 92.6 |

TABLE 2B

| | A reference | E | F | G | H | I |
|---|---|---|---|---|---|---|
| Carcass | radial | two | two | two | two | two |
| structure | mono-ply | crossed | crossed | crossed | crossed | crossed |
| | | plies | plies | plies | plies | plies |
| | | α = 50° | α = 75° | α = 80° | α = 70° | α = 130° |
| | | β = 50° | β = 65° | β = 60° | β = 50° | β = 110° |
| | | Ω = 130° | Ω = 115° | Ω = 120° | Ω = 130° | Ω = 70° |
| | | Δ = 80° | Δ = 40° | Δ = 40° | Δ = 60° | Δ = −60° |
| Belt | two layers | — | — | — | — | — |
| structure | with | | | | | |
| | crossed | | | | | |
| | cords | | | | | |
| Reinforcing | zero degree | zero | zero | zero | zero | zero |
| layer | hybrid | degree | degree | degree | degree | degree |
| | | metallic | metallic | metallic | metallic | metallic |
| | | with | with | with | with | with |
| | | double | double | double | double | double |
| | | slope | slope | slope | slope | slope |
| Weight | 100 | 92.6 | 92.6 | 92.6 | 92.6 | 92.6 |

First of all, it is noted that tyres B, C, D, E, F, G, H, I are lighter than the reference tyre A. In fact, considering the weight of reference A as equal to 100, all eight tyres B, C, D, E, F, G, H, I have a weight reduced by 7.4%.

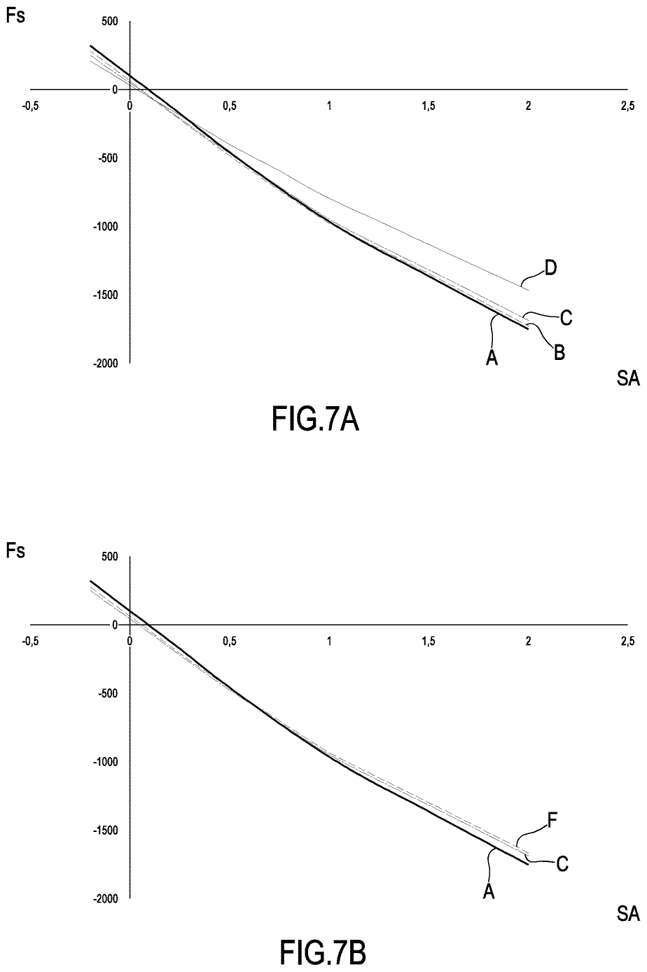

FIG. 6 illustrates the rolling resistance coefficient RR of tyres A, B, C, D, E, F, G, H, I. The rolling coefficient has been normalised by attributing the value 100 to reference A. As may be seen, tyres B, C, D, F, G, H, I have an RR (RR_{B}=87.7, RR_{C}=83.3, RR_{D}=86.0, RR_{F}=83.3, RR_{G}=83.5, RR1_{H}=89.6, RR_{I}=91.6) less than the rolling resistance coefficient RR of the reference tyre A (RR_{A}=100). Tyre E, characterised by smaller angles α and β than the other tyres, instead exhibits a worsening RR (RRE=103.0) compared to reference A. The following Table 3 shows, in addition to the values of RR illustrated in FIG. 6, also the percentage decreases in the rolling resistance coefficient RR of tyres B, C, D, F, G, H, I compared to reference A.

TABLE 3

| | A | | | | | | | |
|---|---|---|---|---|---|---|---|---|
| | reference | B | C | D | F | G | H | I |
| RR % | 100 | 87.7 | 83.3 | 86.0 | 83.3 | 83.5 | 89.6 | 91.6 |
| Decrease | — | −12.3 | −16.7 | −14.0 | −16.7 | −16.5 | −10.4 | −8.4 |
| % | | | | | | | | |

The advantages in terms of reduction of rolling resistance RR shown by tyres B, C, D, F, G, H, I are evident and significant.

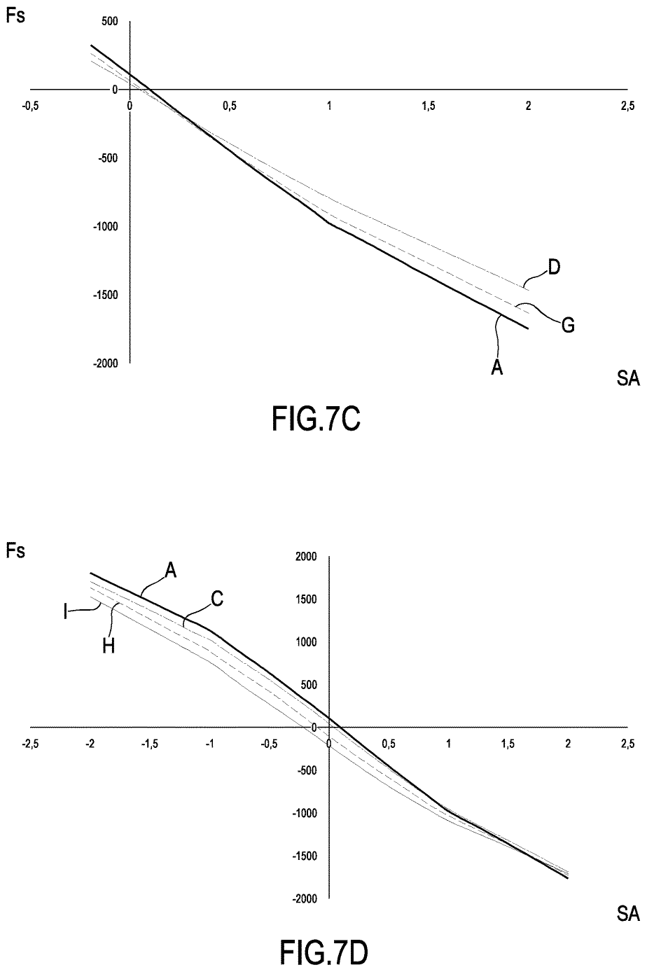

FIGS. 7A-7D illustrate the drift forces Fs (in Newton) as a function of the drift angle SA of tyres A, B, C, D, F, G, H, I at a vertical load of 2866 N (vertical load low) corresponding in working conditions to a wheel on the curved internal side.

At the low vertical load of FIGS. 7A, 7B and 7C, the drift force Fs of tyres B, C, D, F, G passes through zero at a lower drift angle in absolute value than the drift force Fs of the tyre reference A and this improves straight-line centring performance. Furthermore, tyres B, C, F, G generate drift force levels Fs substantially in line with reference A.

With reference to FIG. 7B, tyre F with a slightly asymmetric carcass structure generates drift force levels Fs almost overlapping those of the symmetrical crossed carcass structure of tyre C.

With reference to FIG. 7C, tyre G with a highly asymmetric carcass structure generates drift force levels Fs higher than those of the symmetrical crossed carcass structure of tyre D.

FIG. 7D shows instead that tyres H and I also with carcass structures with a highly asymmetric crossing (but different from tyre G) generate levels of drift force Fs significantly lower in absolute value than those of the carcass structure with a symmetric crossing of tyre C in the negative drift branch (left curve) and marginally higher in the positive drift branch (right curve). Overall, the average drift force which may be developed by tyres H and I at the same drift angle is lower than in the case with a symmetrical carcass structure of tyre C. Furthermore, tyres H and I show a zero crossing of the force at a drift angle of sign opposite to reference A and in absolute value higher and this worsens the centring performance in a straight line.

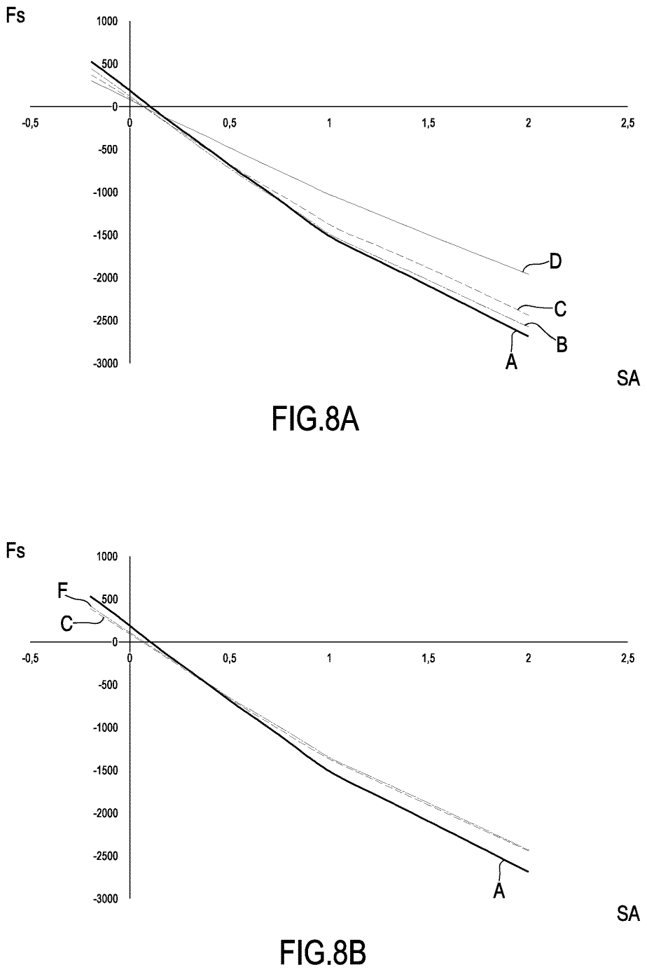

FIGS. 8A-8D illustrate the drift forces Fs as a function of the drift angle SA of the tyres A, B, C, D, F, G, H, I at a vertical load of 4337 N (average vertical load-situation from entering a curve or starting to change lanes on both wheels of the axle).

At the average vertical load of FIGS. 8A, 8B and 8C, tyres B, C, D, F, G continue to have a force zero crossing at a lower drift angle in absolute value than the drift force Fs of the reference tyre A. Furthermore, tyres B, C, F, G generate drift force levels Fs slightly lower than reference A (differences <10%).

With reference to FIG. 8B, tyre F with a slightly asymmetric carcass structure generates drift force levels Fs substantially superimposed on those of the symmetric crossing carcass structure of tyre C. With reference to FIG. 8C, tyre G with a highly asymmetric carcass structure still generates higher levels of drift force Fs than the symmetrically crossed carcass structure of tyre D. FIG. 8D shows that the behaviour of the drift forces generated by tyres H and I (also with strongly crossed carcass structures asymmetric) with medium vertical load is similar to that shown in FIG. 7D with low vertical load.

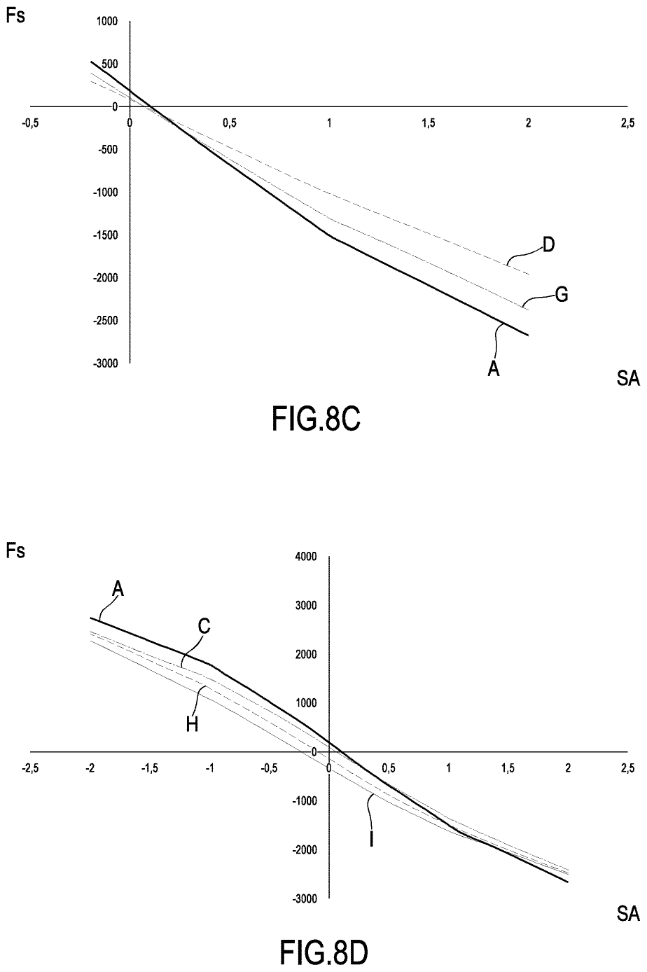

FIGS. 9A-9D illustrate the drift forces F (N) as a function of the drift angle SA of tyres A, B, C, D, F, G, H, I at a vertical load of 5808 N (high vertical load-external wheel resting when cornering).

At the high vertical load of FIGS. 9A, 9B and 9C, tyres B, C, D, F, G continue to have a zero crossing of the drift force Fs at a lower drift angle in absolute value. In these conditions, tyre B (α=60°, β=) 60° continues to have a limited drift force deficit Fs, compared to reference (<10%). Tyre C (α=70°, β=) 70° has a drift force deficit Fs between 15% and 20%.

With reference to FIG. 9B, tyre F with a slightly asymmetric carcass structure continues to generate drift force levels Fs substantially overlapping those of the symmetrical crossed carcass structure of tyre C.

With reference to FIG. 9C, tyre G with a highly asymmetric carcass structure still generates drift force levels Fs higher than those of the symmetrical crossed carcass structure of tyre D.

The deficit in drift force Fs for tyres B, C, F, G is however limited, so much so that it does not give rise to a significant penalty in terms of driving performance potential when cornering.

FIG. 9D shows that the behaviour of the drift forces generated by tyres H and I (also with highly asymmetric crossing carcass structures) with high vertical load is similar to that illustrated in FIG. 7D with low vertical load and in FIG. 8D with medium vertical load.

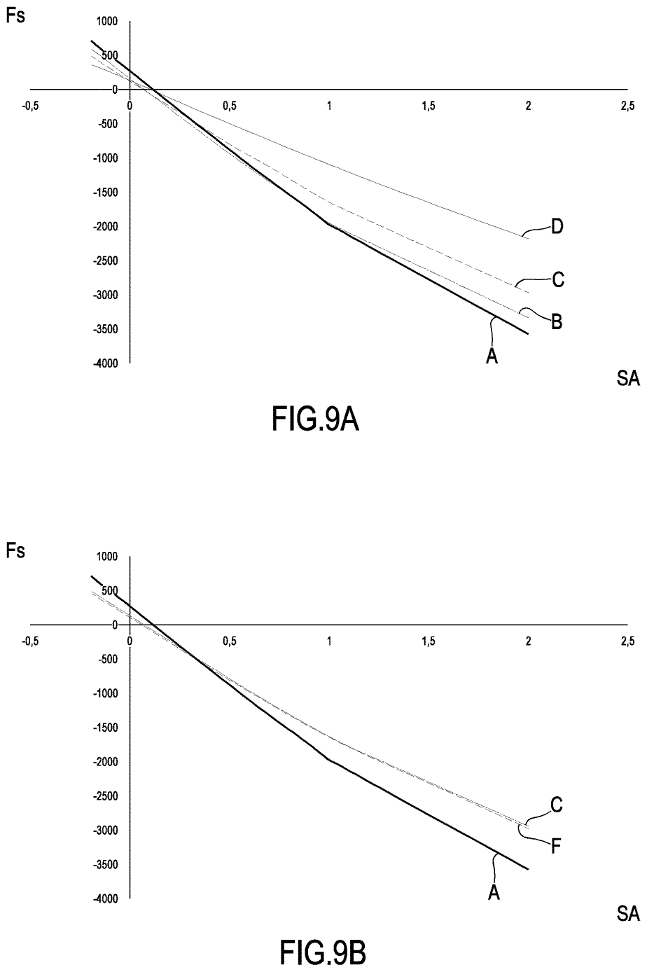

FIG. 10 illustrates the self-aligning torques T (N*m) of tyres A and C as a function of the drift angle SA. There are two curves because they refer to two different tyres for each of the two types of carcass structure.

It may be seen that the curve of the self-aligning torque T (to whose values at the front axle the steering torque is proportional) is more progressive (lower peaks in absolute value, shifted towards higher drift angles in absolute value). The more progressive shape of the tyre C curve is generally preferable, because it reduces the unpleasant loss of self-aligning torque and steering torque for angles in absolute value greater than the peak one. In other words, the more progressive form of the self-aligning torque trend at the front axle determines a more limited and therefore more manageable decline in torque at the steering wheel.

Tyres B, C, D, F, G, which fall within the scope of the present invention, all provide a notable reduction in rolling resistance. Tyres B, C, F, G, in addition to the significant reduction in rolling resistance, also provide excellent cornering performance while the cornering performance of tyre D is still good.

1.-31. (canceled)

32. A beltless tyre for motor vehicles, comprising:
a carcass structure comprising two carcass plies, each of the two carcass plies comprising a plurality of parallel cords and having terminal flaps engaged with respective anchoring annular structures, the parallel cords of the two carcass plies being crossed with respect to each other and forming an intersection angle with respect to each other comprised between 20° and 60°; the parallel cords of each of the two carcass plies delimiting, with a circumferential direction of the tyre, a respective angle comprised between 60° and 80°;
at least one reinforcing cord wound in a plurality of circumferential turns arranged in radially outer position with respect to the carcass structure; and
a tread band applied in radially outer position with respect to the reinforcing cord,
said at least one reinforcing cord having a percentage elongation, and
said at least one reinforcing cord is configured to exhibit a tensile load-elongation relationship according to a curve having:
a first region occurring at elongation values less than the percentage elongation, and
a second region occurring at elongation values greater than the percentage elongation, and
a third, connecting, region occurring at elongation values around the percentage elongation and placed between the first region and the second region, wherein a slope of the second region is greater than a slope of the first region.

33. The tyre according to claim 32, wherein a ratio between the slope of the second region and the slope of the first region is greater than 5 and less than 50.

34. The tyre according to claim 33, wherein the ratio between the slope of the second region and the slope of the first region is comprised between 5 and 40 or between 10 and 35.

35. The tyre according to claim 32, wherein the slope of the first region is comprised between 1 and 20 N/elongation % and wherein the slope of the second region is comprised between 35 and 500 N/elongation %.

36. The tyre according to claim 35, wherein a density of the circumferential turns of said reinforcing cord is comprised between 40 turns/dm and 130 turns/dm or between 75 turns/dm and 115 turns/dm.

37. The tyre according to claim 32, wherein the percentage elongation is comprised between 1% and 5% or between 1.5% and 4.5%.

38. The tyre according to claim 32, wherein in said curve, a force corresponding to the percentage elongation is comprised between 5 N and 200 N or between 15 N and 90 N.

39. The tyre according to claim 32, wherein said at least one reinforcing cord is metallic and comprises a plurality of steel threads, said threads being individually twisted and wound together such that in a plurality of transverse sections of said cord, each thread is not in contact with immediately adjacent threads.

40. The tyre according to claim 32, wherein said at least one reinforcing cord is metallic and comprises at least two strands, each comprising a respective plurality of steel threads, wound together in each strand according to a winding pitch, wherein said at least two strands are wound together in the same sense of said threads in said strands.

41. The tyre according to claim 32, wherein said at least one reinforcing cord is metallic and comprises only one metallic thread, or two or more metallic threads twisted with each other or at least one helix-shaped metallic thread.

42. The tyre according to claim 32, wherein said at least one reinforcing cord is hybrid and comprises one or more textile filaments with high elastic modulus twisted in one direction and one or more textile filaments with low elastic modulus twisted in the same direction, wherein the textile filaments with high elastic modulus and the textile filaments with low elastic modulus are twisted together.

43. The tyre according to claim 32, wherein said at least one reinforcing cord is hybrid, and each yarn of the at least one hybrid reinforcing cord has filaments thereof twisted together according to a respective number of twists per unit of length of the yarn, and the yarns are twisted together according to a number of twists per unit of length of the reinforcing cord.

44. The tyre according to claim 32, wherein said at least one reinforcing cord is hybrid and comprises two aromatic polyamide fibre yarns and one polyamide aliphatic and/or polyester fibre yarn.

45. The tyre according to claim 32, wherein
said at least one reinforcing cord is hybrid and comprises at least one hybrid yarn, comprising a plurality of filaments obtained from a first yarn with filaments having a first initial tangential module and at least one second yarn with filaments having a second initial tangential module, said first initial tangential module and second initial tangential module being different from each other, and
each of said first yarn and second yarn comprises a plurality of individual filaments, said individual filaments of each of said first yarn and second yarn being at least partially mixed together in said hybrid yarn.

46. The tyre according to claim 32, wherein the circumferential turns of said reinforcing cord form, with the circumferential direction, an angle comprised between 0° and 5° and wherein the parallel cords of each of the two carcass plies form, with the circumferential direction of the tyre, an angle comprised between 65° and 75°.

47. The tyre according to claim 32, wherein the parallel cords of the two carcass plies form equal and opposite angles with respect to the circumferential direction of the tyre or wherein the parallel cords of the two carcass plies form different and opposite angles with respect to the circumferential direction of the tyre.

48. The tyre according to claim 32, wherein the intersection angle is comprised between 30° and 50°.

49. The tyre according to claim 32, comprising at least one auxiliary element positioned at each of two opposite axial ends of the plurality of circumferential turns,
wherein the auxiliary element is situated
between the plurality of circumferential turns and the tread band, and/or
between the plurality of circumferential turns and the carcass structure;
wherein said at least one auxiliary element is positioned astride the respective axial end.

50. The tyre according to claim 49, wherein said at least one auxiliary element comprises a material selected from at least one of elastomeric material, aramid and metal and wherein said at least one auxiliary element has an axial extension comprised between 15% and 25% of an axial width of the plurality of circumferential turns.

51. The tyre according to claim 32, wherein said at least one reinforcing cord wound in a plurality of circumferential turns is embedded in a layer of elastomeric material.
